(19) United States
(12) Patent Application Publication
(10) Pub. No.: US 2010/0012708 A1
(43) Pub. Date: Jan. 21, 2010

(54) OILFIELD TOOLS COMPRISING MODIFIED-SOLDERED ELECTRONIC COMPONENTS AND METHODS OF MANUFACTURING SAME

(75) Inventors: Rejanah Steward, Richmond, TX (US); Glen Schilling, Richmond, TX (US); Manuel Marya, Stafford, TX (US); Nitin Vaidya, Missouri City, TX (US); Anthony Collins, Houston, TX (US); Mark Kostinovsky, Houston, TX (US)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation, Sugar Land, TX (US)

(21) Appl. No.: 12/173,914

(22) Filed: Jul. 16, 2008

(51) Int. Cl. B23K 31/02; B23K 35/34; B23K 1/20

(52) U.S. Cl. 228/209; 148/24; 228/101; 228/260; 228/256

(57) ABSTRACT

Oilfield tools, assemblies and methods of manufacturing same are described comprising a modified-soldered electronic component, wherein the modified-solder includes a high-melting metal matrix and from about 0.1 to about 20 weight percent, based on total weight of the modified solder, of a strength-reinforcing additive dispersed in the metal matrix, the additive comprising a polyhedral oligomeric silsesquioxane. Methods of using the oilfield tools and assemblies in oilfield operations are also described.

### TECHNICAL FIELD AND BACKGROUND INFORMATION

The present disclosure relates generally to oilfield tools and assemblies of tools useful in exploration and production of hydrocarbons, and more specifically to tools and assemblies of tools and methods of manufacturing same, the tools including modified-soldered electronic component.

Electronic components used in oilfield service tools, and in particular downhole, must be able to withstand high temperatures (T>175° C., in many embodiments T>300° C., or T>400° C., or even T>500° C. or higher), as well as high pressures (P>200 psig, in many embodiments P>300 psig, or P>600 psig, or higher). These components may also be subject to severe thermo-mechanical fatigue (for example over 500 cycles, or 1000 cycles, or higher). The solder connections in electrical components are thus of extreme importance. Unlike consumer, automotive, and even aerospace electronics, in which the components may simply be replaced, repaired, or sacrificed, many oilfield tools are employed for a variety of purposes in wells that may be thousands, or tens of thousands of feet from the well head. To have the tool fail because of an electrical component failure can be very expensive in terms of time to retrieve the tool, or run another tool downhole, and in lost hydrocarbon production time if the well is a producing well.

United States published patent application 20050034791, published Feb. 17, 2005, discloses a composite solder composition comprising a metal matrix and inorganic oxide particles dispersed therein, the inorganic oxide particles having a bound organofunctional group on a surface of the particles. An electronic apparatus comprising this composite solder composition is also described. In particular, organofunctional POSS particles are described. The term “POSS” refers to polyhedral oligomeric silsesquioxanes and derivatives thereof. The general formula of POSS is [RSiO_{1.5}]ₙ, where R may be an organic moiety which is the same or different at each occurrence, and may be selected from aliphatic, and aromatic hydrocarbon groups. Examples of organic moieties include alkyl, cycloalkyl, alkenyl, cycloalkenyl, alkynyl, cycloalkynyl, aryl, and heteroaryl. This reference also provides information on enhancement of mechanical properties of the resultant solders, such as shear strength and shear ductility. The reference discloses potential use of the composite solders in electronic packaging, MEMS, and automotive/aerospace/defense electronics.

Nanocomposite solders such as those described in the above-referenced published patent application are a relatively new class of composites that are particle-filled solders for which at least one dimension of the dispersed particle is in the nanometer range (10⁻⁹ meter). Because of the size of the dispersed particles, certain nanocomposite solders may exhibit improved mechanical, thermal, thermo-mechanical fatigue (TMF), and electrical properties as compared to previously known lead-based or lead-free solders. However, the degree of improvement in one or more properties through use of POSS additives may vary widely and unpredictably, as quickly becomes apparent in a review of the technology. Such a review is Li et al., “Polyhedral Oligomeric Silsesquioxane (POSS) Polymers and Copolymers: A Review”, Journal of Inorganic and Organometallic Polymers, Vol. 11, No. 3, September, 2001(Li et al.). For example, the effect on the glass transition temperature of POSS incorporation into norbornene ring-opened polymers was investigated. The glass transition temperature, T_{g} of pure polynorbornene is 52.3° C. When 7.7 mol % (50 wt %) of heptacyclohexyl-substituted norbornyl-POSS was present, the T_{g} was raised to 81.0° C. However, POSS copolymerization was observed to have no significant effect on the decomposition temperature, T_{d}. All of the copolymers exhibited a T_{d} of 440° C. Studies of solders have emphasized that it is very difficult to substitute thermal cycling testing for mechanical testing because mechanical properties of solders change as temperature rises, and crack propagation rate of Pb—Sn solders depends on the bond shape. See Satoh, R., et al., “Thermal Fatigue Life of Pb—Sn Alloy Interconnections”, IEEE Transactions on Components, Hybrids, and Manufacturing Technology, Vol. 14, No. 1, March 1991, pp. 224-232 (Satoh et al.). It is probably this unpredictability of POSS effects on polymers, as well as the reported difficulties of cycle testing of solders, and other reasons that, so far as is known to the inventors herein, the use of electronic components employing solders modified with POSS, POSS derivatives, and/or functionalized POSS nanoparticles has not been reported in the oilfield literature for use downhole.

Many oilfield tools utilize soldered electronic components. For printed circuit board assemblies (PCA), thermo-mechanical fatigue (TMF) accelerates solder joint degradation, which affects the tool operation life. Additionally, contamination of other metals introduced through board and lead plating, if not controlled, can cause further exacerbation. The ramifications of a compromised solder joint can result in open circuit failures; hence, loss of vital communication signals for tool sustainability in the field. Although electrical material issues account for approximately 10% or less of the material cost for fabrication when compared to materials used for higher exotic metal consumption parts such as drill collars and electronic chassis, the cost associated with open-circuit failures incurred in the field have the potential to impose a dollar loss that exceeds the cost of procurement and machining of high-dollar parts for commercialization. Conventional high melting solders like those in the Pb-based family are good for handling vibration and shock during TMF, but usage at higher temperatures lowers the tensile strength properties tremendously, as exhibited in FIG. 1 (from FIG. 4b of Satoh et al.). As noted by Satoh et al., one must also consider whether the Pb—Sn eutectic solder samples are cast samples, or rolled and heat treated samples, as the latter exhibit superplastic phenomenon, while the former do not. The reduced strength is most likely attributed to creep. In light of this, there remains a need in the natural resources exploration, production, and testing field for improving reliability and life, as well as electrical properties in some instances, of metallic solders used in oilfield tools used for electromechanical connections in oilfield tools subjected to downhole oilfield environments. Oilfield tools typically use solder to interconnect electronic components or modules for key electrical functions such as electrical controllers, telemetry electronics, optical components, sensors, power supplies, and the like.

### BRIEF DESCRIPTION OF THE DRAWINGS

The manner in which the objectives of the disclosure and other desirable characteristics can be obtained is explained in the following description and attached drawings in which:

FIG. 1 is prior art of a graph illustrating results for tensile stress-strain temperature behavior at elevated temperatures for cast Pb-63Sn eutectic solder;

FIG. 2 is prior art of a chemical structure of a POSS having a silane functional group;

FIG. 3 is prior art of a graph illustrating the effect of TMF on normalized residual shear strength of joints made with various known solders compared to a POSS-reinforced solder;

FIG. 4 is a schematic diagram illustrating one embodiment of how POSS may be incorporated into a favorable vendor HMP paste/bar for automatic soldering applications via intense shear mixing;

FIG. 5 is a schematic diagram illustrating another embodiment of how POSS may be incorporated into a favorable vendor HMP paste/bar for automatic soldering applications via chemical vapor deposition; and

FIGS. 6A, 6B and 6C are three processing routes for producing soldered electronic components in accordance with this disclosure.

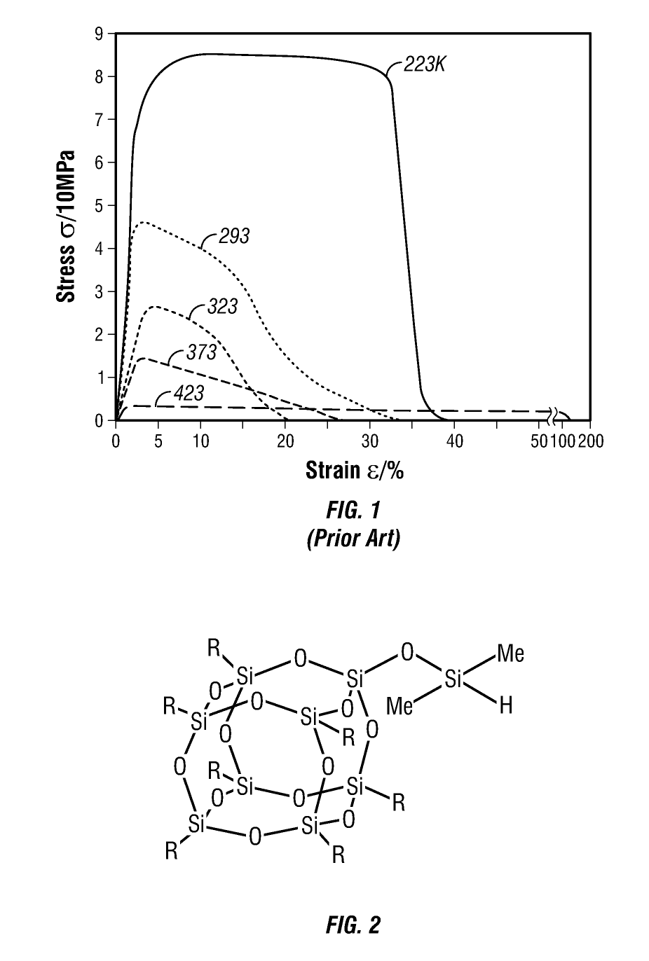

It is to be noted, however, that the appended drawings are not to scale and illustrate only typical embodiments of this disclosure, and are therefore not to be considered limiting of its scope, for the disclosure may admit to other equally effective embodiments.

### DETAILED DESCRIPTION

In the following description, numerous details are set forth to provide an understanding of various embodiments. However, it will be understood by those skilled in the art that other embodiments may be practiced without these details and that numerous variations or modifications from the described embodiments may be possible. All published non-patent literature papers and patent literature referred to herein, whether in this detailed description or elsewhere, is explicitly incorporated herein by reference in their entirety.

In accordance with the present disclosure, oilfield tools comprising modified soldered electronic components are described, and methods of using the oilfield tools, that reduce or overcome problems in previously known oilfield tools comprising soldered electronic components, and methods. By combining the properties of high-melting solders with the properties of an additive comprising a POSS, the modified solders described herein may act to increase the creep resistance and TMF resistance of the solder, decrease solder joint degradation downhole, reduce open-circuit failures, and thus increase tool sustainability in the downhole oilfield environment.

A first aspect of the disclosure is an oilfield tool comprising an electronic component made using a modified-solder, wherein the modified-solder comprises:
(a) a high-melting metal matrix; and
(b) from about 0.1 to about 20 weight percent (or from 0.1 to 15, or from 1 to 10, or from 2 to 9, or from 3 to 8, or from 4 to 7, or from 5 to 6 weight percent) based on total weight of the additive, of a strength-reinforcing additive dispersed in the metal matrix, the additive comprising a polyhedral oligomeric silsesquioxane.

As used herein the term “high-melting” means a composition having a melting point of at least 175° C., or 180° C., or 200° C., or 300° C., or 400° C., or even 500° C. or above.

The term “strength-reinforcing” means the solder retains its strength when subjected to thermo-mechanical fatigue at thermal cycles ranging from 10° C., or 20° C., or 50° C., or 100° C., or 200° C., or 300° C., or 400° C., or even a thermal cycle of 500° C., where the low temperature may be 0° C., or −20° C., or −50° C., or even −100° C. or below, and the high temperature of the thermal cycle may be 150° C., or 200° C., or 250° C., or 300° C., or 350° C., or 400° C., or 450° C., or even 500° C. or above, the thermal cycles ranging from 1 cycle per month to 10 cycles per day, or from 1 to 100 cycles per day, or even 300 thermal cycles per day or higher. Mechanical cycles (tensile and relaxation) may range from 1 cycle per month to 10 cycles per day, or from 1 to 100 cycles per day, or even 300 mechanical cycles per day or higher. The POSS-based solders described herein enhance mechanical properties of solders above 175° C. to reduce TMF for downhole applications due to the optimization of the microstructural morphology.

The term “polyhedral oligomeric silsesquioxane” (or POSS) is defined further in this description, but is essentially a nanostructured chemical, with size ranging from 1 to 3 nanometers in diameter, can be thought of as the smallest possible particles of silica. Unless otherwise stated, the term POSS includes functionalized, oligomeric, and polymeric versions.

The POSS component may be present from about 0.1 to about 20 wt. % (based on total weight of POSS additive), or from about 1 to about 19, or from 1 to 18, or from 1 to 17, or from 1 to 16, or from 1 to 15, or from 1 to 14, or from 1 to 13, or 1 to 12, or 1 to 11, or 1 to 10, or 1 to 9, or 1 to 8, or 1 to 7, or 1 to 7, or 1 to 6, or 1 to 5, or 1 to 4, or 1 to 3, or even 1 to 2 wt. %.

The metal matrix comprises one or more metals, for example, but not limited to, metals selected from the group consisting of tin, lead, silver, gold, zinc, gallium, aluminum, magnesium, lanthanide, zirconium, hafnium, indium, bismuth, zinc, copper, and mixtures thereof. Examples of metal matrices useful in solders useful in the downhole electronics described herein are given in Table 1, from Plumbridge, W. J., “Review: Solders in Electronics”, Journal of Materials Science 31 (1996) 2501-2514, p. 2502 (Plumbridge), however, this disclosure is explicitly not limited to those matrices.

Metal matrix materials useful in the disclosure may be layered, wherein individual layers may be the same or different in composition and thickness. The term “metal matrix” includes composites, such as, but not limited to, materials having “non-nanometer scale” fillers, plasticizers, and fibers therein, wherein “non-nanometer-scale” refers to 1000 nm (1 micrometer) or larger.

Castable metallic materials that may be used are those having a high melting temperature, good heat resistant properties, and good toughness properties such that the oilfield tool or assemblies containing these materials operably withstand oilfield conditions without substantially deforming or disintegrating.

Metallic materials useful as metal matrix materials are those able to withstand expected temperatures, temperature changes, and temperature differentials (for example a temperature differential from one surface of a bond to the other surface material to the other surface) during use, as well as expected pressures, pressure changes, and pressure differentials during use, with a safety margin on temperature and pressure appropriate for each application.

Other such materials that may be added to the metal matrix for certain applications of the present disclosure include inorganic or organic nano-sized fillers (other than POSS). Inorganic fillers are also known as mineral fillers. A nano-sized filler is defined as a particulate material, typically having a particle size less than about 100 nanometers, preferably less than about 50 nanometers, but larger than about 0.1 nanometer. Examples of useful fillers for applications of the present disclosure include carbon black, calcium carbonate, silica, titanium, calcium metasilicate, cryolite, and the like. If a filler is used, it is theorized that the filler may fill in between the POSS nanoparticles, or between reinforcing fibers if used, and may prevent crack propagation through the substrate. Typically, a filler would not be used in an amount greater than about 20%, based on the weight of the metal matrix.

TABLE I
Compositions and properties of base solders

| | | Soli- | Tensile | %0.2 | Uniform |
|---|---|---|---|---|---|
| Alloy composition | Liquidus | dus | strength | Proof | elongation |
| (wt %) | (° C.) | (° C.) | (MPa) | strength | (%) |
| 63Sn—37Pb | 183 | 183 | 35.4 | 16.1 | 1.4 |
| 60Sn—40Pb | 190 | 183 | 28.0 | 14.2 | 5.3 |
| 25Sn—75Pb | 266 | 183 | 23.1 | 14.2 | 8.4 |
| 10Sn—90Pb | 302 | 268 | 24.3 | 13.9 | 18.3 |
| 5Sn—95Pb | 312 | 308 | 23.2 | 13.3 | 26.0 |
| 80Sn—20Pb | 199 | 183 | 43.2 | 29.6 | 0.8 |
| 42Sn—58Bi | 138 | 138 | 66.9 | 41.6 | 1.3 |
| 70Sn—30In | 175 | 117 | 32.2 | 17.5 | 2.6 |
| 95Sn—5Ag | 240 | 221 | 55.8 | 40.4 | 0.84 |
| 40Sn—60In | 122 | 113 | 7.6 | 4.6 | 5.5 |
| 95Sn—5Sb | 240 | 235 | 56.2 | 38.1 | 0.85 |
| 95Pb—5In | 314 | 292 | 25.2 | 13.9 | 33.0 |
| 70Pb—30In | 253 | 240 | 33.3 | 24.7 | 15.1 |
| 95Pb—5Sb | 295 | 252 | 25.6 | 16.9 | 13.7 |
| 85Pb—10Sk~5Sn | 255 | 245 | 38.4 | 25.3 | 3.5 |
| 88Pb—10Sn—2Ag | 290 | 268 | 27.2 | 15.5 | 15.9 |
| 97.5Pb—1Sn—1.5Ag | 309 | 309 | 38.5 | 29.9 | 1.15 |
| 85Sn—10Pb—5Sb | 230 | 188 | 44.5 | 25.0 | 1.40 |

It should be understood that the compositions listed in Table 1 are merely examples, and that other mixtures are possible. It should also be understood that two compositions that were in Plumbidge's list were not acceptable and were deleted. These were a 42Sn-58Bi solder (liquidus of 138° C.), and a 4OSn-601n solder (liquidus of 122° C.). In general, lead, if present in the solder, may range from about 30 to about 99 wt. %, or from about 35 to about 95, or from about 30 to about 50, or form about 60 to about 85, or from about 80 to about 95 wt. %. Tin, if present, may range from about 1 to about 99, or from about 1 to about 10, or from about 50 to about 99, or from about 70 to about 90 wt. %. Indium, if present, may range from about 30 to about 99 wt. %, or from about 35 to about 95, or from about 30 to about 50, or form about 60 to about 85, or from about 80 to about 95 wt. %. Silver, if present, may range from about 1 to about 50 wt. %, or from about 3 to about 40, or from about 5 to about 30 wt. %. All weight percentages are based on total weight of the metallic components only and do not include POSS.

Blends of different metals, layered versions, wherein individual layers may be the same or different in composition and thickness, are considered within this disclosure. The term “matrix” is not meant to exclude any particular form or morphology for the metallic base solder and is used merely as a term of convenience. The term includes composite materials, such as, but not limited to, metallic materials having fillers and fibers therein other than POSS.

In certain embodiments at least a portion of the POSS may be surface modified to enhanced dispersion in the metal matrix, or enhance bonding with the metal matrix, or both. As a specific example, attaching functional groups on POSS may increase the bound POSS content in the resultant solder, which may enhance TMF resistance of the resultant solder and increase life of the oilfield tool. Functional groups that may enhance bonding POSS to the metal matrix will depend on the metal or metals comprising the metal matrix. For example, functional groups comprising tin may increase dispersion in metal matrices including tin. In certain embodiments, the additive(s) remains in suspension in the metal matrix and do not become macro-segregated.

The oilfield tool may be selected from telemetry and surveying tools, reservoir sampling and pressure tools, formation evaluation tools, optical components having soldered parts, sensors based on or employing soldered electronic components, retrieval and fishing tools, bottom hole assemblies, locators, sensor protectors, and the like, and combinations thereof. An “oilfield assembly”, as used herein, is the complete set or suite of oilfield tools that may be used in a particular job. All oilfield tools in an oilfield assembly may or may not be interconnected, and some may be interchangeable.

Another aspect of the disclosure is an oilfield assembly for exploring for, drilling for, or producing hydrocarbons, comprising:

(a) one or more oilfield tools; and

(b) one or more of the oilfield tools comprising a modified solder comprising:
(i) a high-melting metal matrix; and
(ii) from about 0.1 to about 20 weight percent, based on total weight of the solder, of a strength-reinforcing additive dispersed in the metal matrix, the additive comprising a polyhedral oligomeric silsesquioxane.

Oilfield assemblies within the disclosure include those comprising one or more oilfield tools selected from telemetry and surveying tools, reservoir sampling and pressure tools, formation evaluation tools, optical components having soldered parts, sensors based on or employing soldered electronic components, retrieval and fishing tools, bottom hole assemblies, locators, sensor protectors, and combinations thereof. Oilfield assemblies within the disclosure include those wherein the polyhedral oligomeric silsesquioxane may be functionalized by one or more functional groups, such as functional groups independently selected from the group consisting of silane, metal, hydride, halogen, hydroxide, nitrile, amine, isocyanate, styryl, olefin, acrylic, epoxide, norbornyl, bisphenol, acid chloride, alcohol, and acid; those wherein the polyhedral oligomeric silsesquioxane has a structure selected from the group consisting of cage structures and partial cage structures; and those wherein the polyhedral oligomeric silsesquioxane is selected from polymers and copolymers. The high-melting metal matrix may comprise one or more metals, for example, but not limited to, metals selected from the group consisting of tin, lead, silver, gold, zinc, gallium, aluminum, magnesium, lanthanide, zirconium, hafnium, indium, bismuth, zinc, copper, and mixtures thereof.

Methods of the disclosure may include, but are not limited to, processing the modified solder according to routes depicted in FIGS. 6A, 6B, and 6C, discussed herein.

Certain oilfield tool embodiments inhibit TMF when used in downhole and other oilfield service applications where one or more of the following conditions exist: 1) a differential pressure applied across the solder; 2) high temperature; 3) high pressure; 4) presence of low molecular weight molecules and gases such as methane, carbon dioxide, and hydrogen sulfide, and the like. Furthermore, the addition of POSS may simultaneously retain the electrical conductivity and enhance the mechanical properties of the metal matrix, and therefore the reliability of the oilfield tools.

Oilfield applications include exploration, drilling, testing, completion, and production activities. As used herein the term “oilfield” includes land based (surface and sub-surface) and sub-seabed applications, and in certain instances seawater applications, such as when exploration, drilling, or production equipment is deployed through seawater. The term “oilfield” as used herein includes oil and gas reservoirs, and formations or portions of formations where oil and gas are expected but may ultimately only contain water, brine, or some other composition.

In one embodiment, the number of functional groups on functionalized silesquioxanes (that is, the functionality) useful in accordance with embodiments set forth herein varies between 1 and 10 inclusive. According to this embodiment, the functionalized silesquioxane may be oligomeric or polymeric. The degree of oligomerization or polymerization that is chosen depends upon the specific application. In one embodiment, the functionality is in a range from about 1 to about 10. In another embodiment, the functionality is from about 3 to about 6. In another embodiment, the functionality is about 5. In some embodiments, functionalized silesquioxanes having silane functional groups are utilized. In alternative embodiments the functionalized silesquioxanes are functionalized by other functional groups. FIG. 2 is a chemical structure of a POSS having a silane functional group.

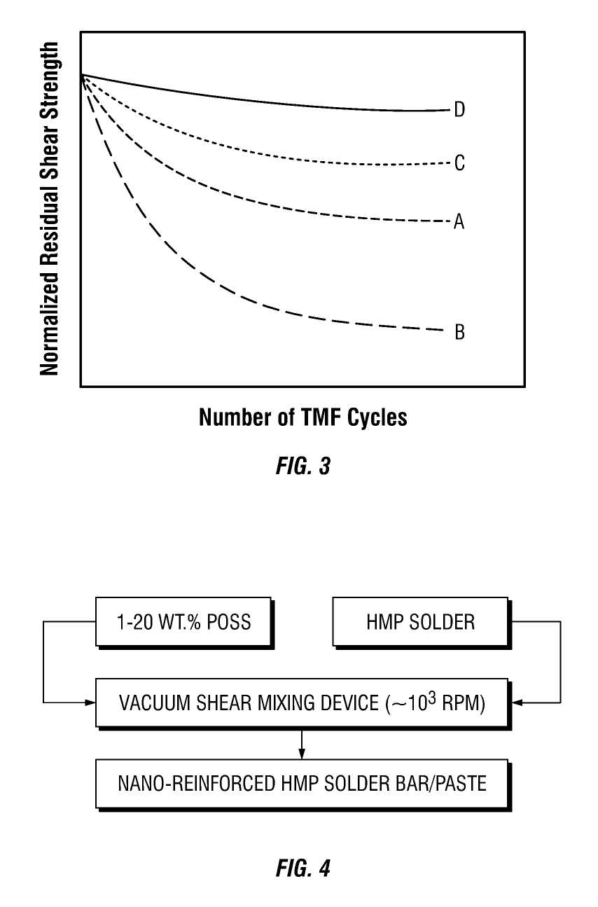

FIG. 3 is a graph illustrating the effect of TMF on normalized residual shear strength of joints made with various known solders compared to a POSS-reinforced solder. Curve A is an eutectic Sn—Ag; Curve B is a Sn—Ag—Cu; Curve C is a Sn—Ag—Cu—Ni; and Curve D a POSS reinforced solder.

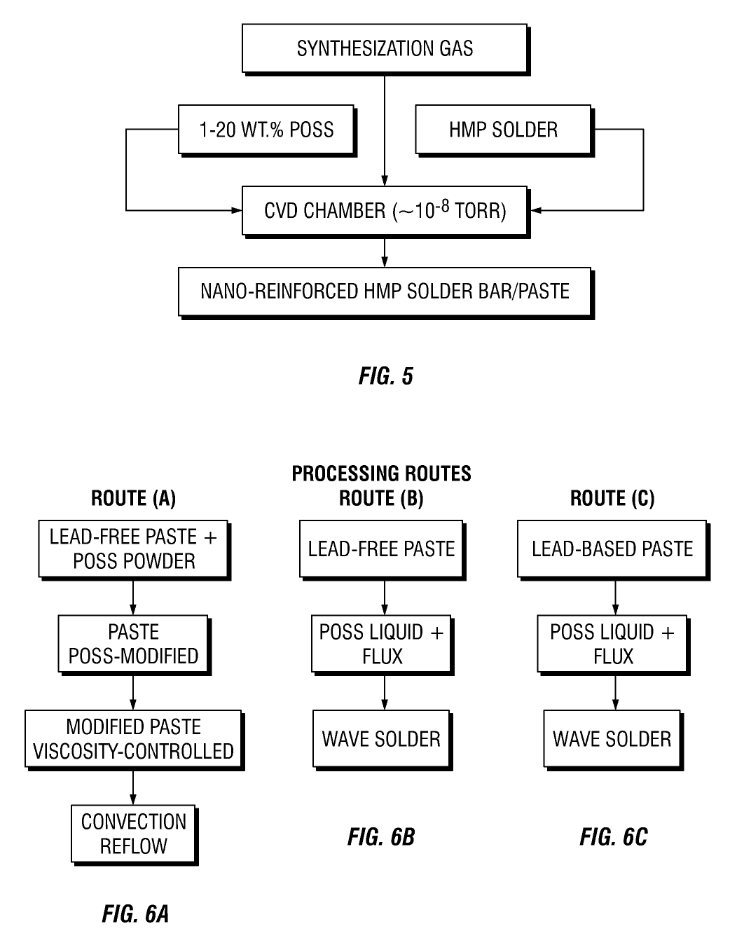

In one embodiment, the POSS is directly incorporated into a favorable vendor HMP paste/bar for automatic soldering applications via intense shear mixing, as depicted schematically in FIG. 4. Further enhancement control may comprise the addition of other, non-POSS nanometer-sized particulates, which may be incorporated into a solder paste/bar via chemical vapor deposition (CVD) of a synthesization gas or vapor, as depicted schematically in FIG. 5. Once dispersed into the solder paste/bar, the POSS will tend to segregate along grain boundaries upon solidification of the solder. Faster cooling rates may tend to form a spheroidal structure, whereas slower cooling rates may tend to form a lamellar structure. In other embodiments, a functionalized POSS may be mixed with other compositions and/or with particles in order to achieve specific mixture embodiments and/or composite embodiments. Examples of non-POSS nanometer-sized particulates that may be added (up to 10 weight percent based on total weight of the modified solder) include carbon nanoparticles, for example, but not limited to, carbon nanotubes, carbon nanowires, carbon nanohorns, and the like. Carbon may be partially substituted in these nanoparticles by other ingredients, as desired, and the nanoparticles may be functionalized, non-functionalized, or mixture thereof. Examples CVD synthesization gases include acetylene, carbon monoxide, methane, hydrogen, and mixtures thereof. CVD is a well-known process using well-known apparatus, and those skilled in the art of semiconductor manufacturing will be well-acquainted with such processes and apparatus. One skilled in the CVD art would know how much of these gases to use, and the physical parameters of the CVD process (pressures, temperatures) without undue experimentation. Variations of CVD, such as, but not limited to, plasma-enhanced CVD (PECVD) may be employed.

POSS compounds have been described as true hybrid inorganic-organic architectures, which contains an inner inorganic framework made up of silicon and oxygen (SiO_{1.5})ₓ, that is externally covered by organic substituents. (See Li et al., page 125) These substituents can be totally hydrocarbon in nature or they can embody a range of polar structures and functional groups. POSS nanostructured chemicals, with sizes of from 1 to 3 nm in diameter, can be thought of as the smallest possible particles of silica. They may be viewed as molecular silicas. However, unlike silica, silicones, or fillers, each POSS molecule may comprise substituents on its outer surface that make the POSS nanostructure compatible with solders. The substituents can be specially designed to be nonreactive or reactive. A variety of POSS nanostructured chemicals has been prepared which contain one or more covalently bonded reactive functionalities that are suitable for polymerization, grafting, surface bonding, or other transformations. See U.S. Pat. No. 5,942,638, and Lichtenhan, J. D. et al., Chem. Innovat. 1, 3 (2001). Unlike traditional organic compounds, POSS chemicals release no volatile organic components, so they are odorless and environmentally friendly. A large-scale process for POSS monomer synthesis has been developed by Hybrid Plastics Company, Fountain Valley, Calif., and a number of POSS reagents. As a result, monomers have recently become commercially available as solids or oils. A selection of POSS chemicals now exist that contain various combinations of nonreactive substituents and/or reactive functionalities. Thus, POSS nanostructured chemicals may be easily incorporated into common plastics via copolymerization, grafting, or blending. See Haddad, T. S., et al., Polym. Prepr. 40(1), 496 (1999). The incorporation of POSS derivatives into polymeric materials can lead to dramatic improvements in polymer properties which include, but are not limited to, increases in use temperature, oxidation resistance, surface hardening, and improved mechanical properties, as well as reductions in flammability, heat evolution, and viscosity during processing. These enhancements have been shown to apply to a wide range of thermoplastics and a few thermoset systems. Ellsworth et al., Polym. News 24, 331 (1999); Haddad et al., Polym. Prepr. 40(1), 496 (1999).

POSS structures that may be useful in solders for downhole electronics include those having cage structures and partial cage structures. Some examples are depicted in structures which follow:

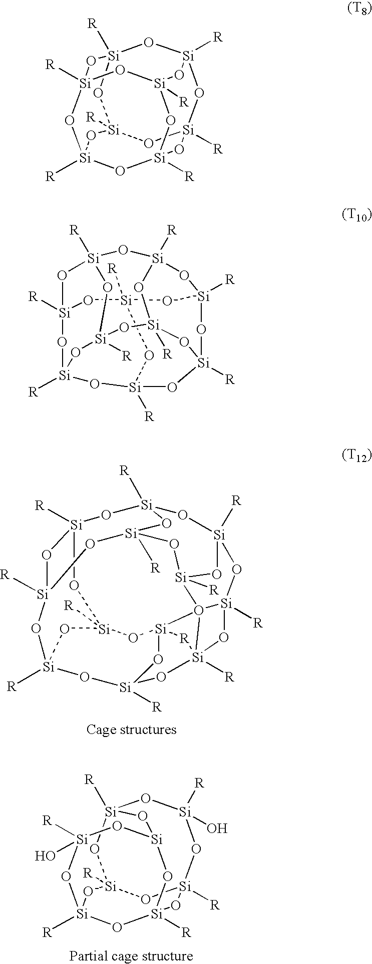

Functionalized POSS useful in the disclosure may be mono-functional or multi-functional. Examples of suitable mono-functional POSS macromonomers useful in the disclosure include those having the structure:

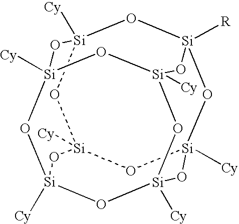

wherein “Cy” is cyclohexyl, and R may be selected from the group consisting of hydride, chloride, hydroxide, nitriles, amines, isocyanates, styryls, olefins, acrylics, epoxides, norbornyls, bisphenols, acid chlorides, alcohols, acids.

Multifunctional POSS suitable for use in solders in the oilfield tools described herein include POSS (RSiO_{1.5})ₙ, where R═H and n=8, 10, 12, 14, or 16, are structures generally formed by hydrolysis and condensation of trialkoxysilanes (HSi(OR)₃) or trichlorosilanes (HSiCl₃). Those useful in the present disclosure include those synthesized by condensations of XSiY₃ precursors, wherein X may be selected from H, alkyls (such as CH₃, C2H5, C₆H₁₁), alkenyls (such as CH═CH₂), and benzyl (C₆H₅), and the like, and wherein Y may be selected from alkoxy (such as OCH₃, OC₂H₅), halogens, and the like. An example structure is given:

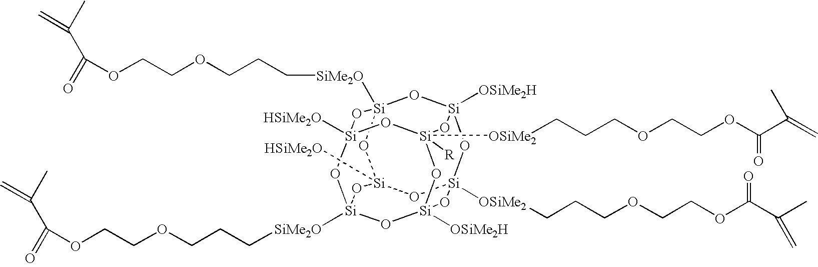

Multifunctional POSS derivatives may be useful for use in solders in the oilfield tools described herein, and can be made by the condensation of ROESi(OEt)₃, where ROE is a reactive group. This reaction produces an octa-functional POSS, R-8(SiO1.5)₈. Another approach involves functionalizing POSS cages that have already been formed. For example, this may be accomplished via Pt-catalyzed hydrosilylation of alkenes or alkynes with (HSiO1.5)₈ and (HMe₂SiOSiO1.5)₈ cages. See for example the following articles: Zhang et al., J. Am. Chem. Soc. 122, 6979 (2000); Sellinger et al., Macromolecules 29, 2327 (1996); Sellinger et al., Chem. Mater. 8(8), 1592 (1996); Hasegawa, J. Sol-Gel Sci. Technol. 1, 57 (1993); and Hasegawa et al., J. Organomt. Chem. 441, 373 (1992).

POSS polymers and copolymers may be useful in the solders used in downhole electronics. As discussed in Li et al., at 131, POSS feedstocks, which have been functionalized with various reactive organic groups, can be incorporated into virtually any existing polymer system through either grafting or copolymerization. POSS homopolymers can also be synthesized. Examples of POSS polymers and copolymers that may be useful in the present disclosure include the following categories.

Styryl-POSS polymers and copolymers may be useful, including those having the formula R₇(Si₈O₁₂)(CH₂CH₂C₆H₄CH═CH₂) (where R=either cyclohexyl or cyclopentyl), may be useful in solders used in downhole electronics. These polymers may be made in accordance with Haddad et al., Macromolecules 29(22), 7302 (1996).

Methacrylate (MA)-POSS polymers and copolymers may be useful in solders used in downhole electronics. Methacrylate-substituted POSS macromers have been made that contain one polymerizable functional group. These macromers have been both homo- and copolymerized, in accordance with Lichtenhan et al., Macromolecules 28, 8435 (1995). Propyl methacrylate-substituted POSS monomers containing seven nonreactive cyclohexyl or cyclopentyl groups, respectively, are examples. Example of synthesis of MA-POSS homopolymers and copolymers, as well as P((MA-POSS)-b-BA-b-(MA-POSS)) triblock and P(MA-b-(MA-POSS)) star-block copolymers is described in Li et al., (page 134).

Norbornyl-POSS copolymers, such as random copolymers of heptacyclohexyl or heptacyclopentyl monofunctional norbornyl POSS monomers with norbornene, may be used in solders useful in downhole electronics. Norbornyl-POSS copolymers may be synthesized under nitrogen by ring-opening metathesis polymerization (ROMP), with Mo(C₁₀H₁₂)(C₁₂H₁₇N)(OC₄H₉)₂ used as the catalyst in chloroform, in accordance with Mather et al., Macromolecules 32(4), 1194 (1999), who reported various weight ratios of norbornene versus norbornyl-POSS (100/0, 90/10, 80/20, 70/30, 60/40, and 50/50). Copolymerizations were designed to produce a degree of polymerization of about 500 by controlling the monomer to catalyst ratio.

Vinyl-POSS copolymers have been produced, and these may be used in solders useful in downhole electronics. The heptaethyldec-9-enyl POSS monomer with a single terminal olefin function has been employed to incorporate POSS moieties into polyolefins. Copolymers of this monovinyl POSS monomer with ethene and propene were synthesized using different methylalumoxane-activated metallocene catalysts, as reported by Tsuchida et al., Macromolecules 30(10), 2818 (1997), who disclosed that depending on the catalyst structure, POSS comonomer incorporation of between 17 and 25 wt % may be achieved. Incorporation of 25 wt % (1.2 mol %) of the vinyl-POSS into the ethene copolymer caused a decrease in the melting temperature by 18° C. versus that of polyethene (PE).

POSS cages multifuntionalized with several vinyl groups have been used to develop new micro- and mesoporous hybrid materials, cross-linked polymers, or other three dimensional structures that may be useful in solders in downhole electronics. Zhang et al., J. Am. Chem. Soc. 120, 8380 (1998) copolymerized polyhedral octahydridosilsesquioxane, (HSiO_{1.5})₈, and (HSiMe₂O)SiO_{1.5})₈, with stoichiometric amounts of the octavinylsilsesquioxane, (CH₂═CH—SiO_{1.5})₈, and ((CH₂═CH—SiMe₂O)SiO_{1.5})₈. These polymerizations proceed via successive hydrosilations in toluene using platinum divinyltetramethyldisiloxane as the catalyst.

Epoxy-POSS copolymers have also been produced, and may have value in solders useful in downhole electronics. The monofunctional epoxy-substituted POSS monomer, [(c-C₆H₁₁)₇Si₈O₁₂(CH₂CHCH₂O)], was incorporated into an epoxy resin network composed of the two difunctional epoxies, diglycidyl ether of bisphenol A (DGEBA) and 1,4-butanediol diglycidyl ether (BDGE), at a DGEBA/BDGE mole ratio of 9/1. The diamine-terminated poly(propylene oxide) known under the trade designation JEFFAMINE D230, composed of an average of 38 propylene oxide molecules, with a Mw of 2248, was employed as the curing agent in an amount that gave a 1:1 equivalent of epoxy-to-amine functions. See Lee et al., Macromolecules 31, 4970 (1998); and Lee et al., Polym. Mater. Sci. Eng. 82, 235 (2000).

Siloxane-POSS Copolymers have been produced, and may have use in solders useful in downhole electronics described herein. Lichtenhan et al. Macromolecules 26, 2141 (1993) prepared POSS-siloxane copolymers. Two methods were employed. The first involved reacting the silanol-functionalized POSS macromer 27 with a bis(dimethyl amine)-substituted silane or a siloxane comonomer. A dichlorosilane or siloxane monomer could also be used in this method to generate POSS-siloxane copolymers. The second route involved the hydrosilation of allyl-substituted POSS macromers, R7Si₈O₁₂(CH₂—CH═CH₂ ), where R=cyclohexyl or cyclopentyl, with poly(hydridomethyl-codimethyl siloxane). Hydrosilation places pendant POSS units along the polysiloxane backbone of the resulting polymers. The T_{g} of these copolymers increased with an increase in their POSS monomer content.

The POSS cages with organic functions attached to its corners have typical diameters of 1.2 to 1.5 nm. Therefore, each POSS monomer occupies a substantial volume. When that POSS monomer is monosubstituted, it cannot contribute to cross-linking. A 2 mol % loading of POSS in a resin might actually occupy 6 to 20 vol % of the resin, and this occupied volume contains no cross-links. Therefore, the average cross-link density will be lowered. Conversely, when a polyfunctional POSS monomer is employed, several bonds can be formed from the POSS cage into the matrix, thereby making the POSS cage the center of a local cross-linked network.

Other POSS-like structures may be useful in the solders used in downhole electronics and tools described herein. Incompletely condensed POSS cages have been used to synthesize metal-containing, closed-cage polyhedral silsesquioxanes for use as silica supported metal catalysts. Example gallium-containing cage silsesquioxanes (as reported by Feher et al., Inorg. Chem. 36(18), 4082 (1997)) and an aluminosilsesquioxane (as reported by Edelmann et al., Inorg. Chem. 38(2), 210 (1999); and Ukrainczyk et al., J. Phys. Chem. B 101(4), 531 (1997) are known. Additional metal-containing polyhedral silsesquioxane examples include Mg-silsesquioxane (as described by Ukrainczyk et al., J. Phys. Chem. B 101(4), 531 (1997); lanthanide silsesquioxane (as described in Annand et al., Inorg. Chem. 38(17), 3941 (1999)), zirconium and hafnium silsesquioxane complexes (as described by Duchateau et al., Organometallics 17(26), 5663 (1998)); and titanium-silsesquioxane (as described by Duchateau et al., Organometallics 17(24), 5222 (1998) and Duchateau et al., Organometallics 18(26), 5447 (1999)). Furthermore, in 2000 Lorenz et al., Coord. Chem. Rev. 206-207, 321 (2000) reviewed all the available literature on polyhedral metallasilsesquioxanes of the early transition metals and f-elements. In 1996 Murugavel et al. Chem. Rev. 96, 2205 (1996) comprehensively reviewed all research up to that time on hetero- and metallasiloxanes derived from silanediols, disilanoles, silanetriols, and trisilanols. As these POSS materials include metal atoms, there may be synergistic effects with metal atoms in the metal matrices of solders useful in the oilfield tools of the disclosure.

Another aspect of the disclosure are methods of manufacturing an oilfield tool having one or more soldered electronic components, the method comprising:

(a) providing a modified-solder as described herein; and

(b) soldering at least some of the components using the modified-solder.

FIGS. 6A, 6B and 6C are three possible processing routes for producing modified-soldered electronic components in accordance with this disclosure. Other routes are possible. FIG. 6A illustrates Route (A), where a lead-free solder paste is mixed with a POSS powder to form a POSS modified-solder paste. FIG. 6B illustrates Route (B), where a lead-free solder paste is combined with a POSS liquid plus a known flux, and then used in a wave soldering apparatus in known fashion. Examples of known fluxes include, but are not limited to, water soluble fluxes and rosin mildly-activated (RMA) fluxes. FIG. 6C illustrates Route (C), which is essentially the same as Route (B), except a lead-based solder is employed. Reflow and wave soldering are well-known processes using well-known apparatus, and those skilled in the art of electronics component packaging and soldering will be well-acquainted with such processes and apparatus.

Although only a few exemplary embodiments of this disclosure have been described in detail above, those skilled in the art will readily appreciate that many modifications are possible in the exemplary embodiments without materially departing from the novel teachings and advantages of this disclosure. Accordingly, all such modifications are intended to be included within the scope of this disclosure as defined in the following claims.

What is claimed is:

1. An oilfield tool comprising an electronic component made using a modified-solder, wherein the modified-solder comprises:
(a) a high-melting metal matrix; and
(b) from about 0.1 to about 20 weight percent, based on total weight of the modified solder, of a strength-reinforcing additive dispersed in the metal matrix, the additive comprising a polyhedral oligomeric silsesquioxane.

2. The oilfield tool of claim 1 wherein the high-melting metal matrix comprises a metal selected from the group consisting of tin, lead, silver, gold, zinc, gallium, aluminum, magnesium, lanthanide, zirconium, hafnium, indium, bismuth, zinc, copper, and mixtures thereof.

3. The oilfield tool of claim 1 wherein the high-melting metal matrix has a melting point of at least 175° C.

4. The oilfield tool of claim 1 wherein the polyhedral oligomeric silsesquioxane is functionalized by one or more functional groups.

5. The oilfield tool of claim 4 wherein the functional groups are independently selected from the group consisting of silane, metal, hydride, halogen, hydroxide, nitrile, amine, isocyanate, styryl, olefin, acrylic, epoxide, norbornyl, bisphenol, acid chloride, alcohol, and acid.

6. The oilfield tool of claim 5 wherein the polyhedral oligomeric silsesquioxane has a structure selected from the group consisting of cage structures and partial cage structures.

7. The oilfield tool of claim 1 wherein the polyhedral oligomeric silsesquioxane is selected from polymers and copolymers.

8. The oilfield tool of claim 7 wherein the polyhedral oligomeric silsesquioxane polymer and copolymer are selected from the group consisting of styryl-POSS polymers and copolymers, methacrylate (MA)-POSS polymers and copolymers, norbornyl-POSS polymers and copolymers, vinyl-POSS polymers and copolymers, epoxy-POSS polymers and copolymers, and siloxane-POSS polymers and copolymers.

9. The oilfield tool of claim 1 wherein the polyhedral oligomeric silsesquioxane comprises closed-cage polyhedral oligomeric silsesquioxane comprising one or more metal atoms.

10. The oilfield tool of claim 9 wherein the metal atom is selected from the group consisting of tin, lead, silver, gold, zinc, gallium, aluminum, magnesium, lanthanide, zirconium, hafnium, titanium, and mixtures thereof.

11. The oilfield tool of claim 1 wherein the polyhedral oligomeric silsesquioxane has a size ranging from about 1 nanometer to about 3 nanometers.

12. The oilfield tool of claim 1 wherein the polyhedral oligomeric silsesquioxane is selected from the group consisting of those within the structural formula: 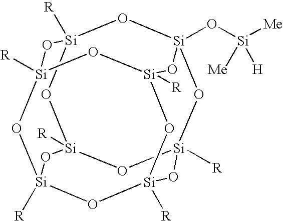
wherein the R groups are independently selected from hydrogen, alkanes having from 1-10 carbon atoms, alkenes having from 1-10 carbon atoms, alkynes having from 1-10 carbon atoms, alkoxy having from 1-10 carbon atoms, aldehydes, ketones, carboxylic acids, epoxides, esters, aromatic moieties, heterocyclic moieties.

13. The oilfield tool of claim 1 wherein the additive further comprises a non-POSS nano-sized component.

14. The oilfield tool of claim 1 selected from telemetry and surveying tools, reservoir sampling and pressure tools, formation evaluation tools, optical components having soldered parts, sensors based on or employing soldered electronic components, power supplies, and combinations thereof.

15. An oilfield assembly for exploring for, drilling for, or producing hydrocarbons, comprising:
(a) one or more oilfield tools; and
(b) one or more of the oilfield tools comprising an electronic component made using a modified-solder, the modified-solder comprising:
(i) a high-melting metal matrix; and
(ii) from about 0.1 to about 20 weight percent, based on total weight of the modified-solder, of a strength-reinforcing additive dispersed in the metal matrix, the additive comprising a polyhedral oligomeric silsesquioxane.

16. The oilfield assembly of claim 15 wherein the oilfield tool is selected from telemetry and surveying tools, reservoir sampling and pressure tools, formation evaluation tools, optical components having soldered parts, sensors based on or employing soldered electronic components, retrieval and fishing tools, bottom hole assemblies, locators, sensor protectors, and combinations thereof.

17. The oilfield assembly of claim 15 wherein the high-melting metal matrix comprises a metal selected from the group consisting of tin, lead, silver, gold, zinc, gallium, aluminum, magnesium, lanthanide, zirconium, hafnium, indium, bismuth, zinc, copper, and mixtures thereof.

18. The oilfield assembly of claim 15 wherein the high-melting metal matrix has a melting point of at least 175° C.

19. The oilfield tool of claim 15 wherein the additive further comprises a non-POSS nano-sized component.

20. A method of manufacturing an oilfield tool having one or more soldered electronic components, the method comprising:
(a) providing a modified-solder comprising:
i) a high-melting metal matrix; and
ii) from about 0.1 to about 20 weight percent, based on total weight of the modified-solder, of a strength-reinforcing additive dispersed in the metal matrix, the additive comprising a polyhedral oligomeric silsesquioxane (POSS); and
(b) soldering at least some of the components using the modified-solder.

21. The method of claim 20 wherein the POSS is directly incorporated into a favorable vendor HMP solder paste or bar via intense shear mixing.

22. The method of claim 20 comprising adding other non-POSS nanometer-sized particulates to the solder paste or bar via chemical vapor deposition of a synthesization gas.

23. The method of claim 20 wherein the high-melting metal matrix is a lead-free solder paste, the POSS is a POSS in powder form, and step (a) comprises combining the lead-free solder paste with the POSS in powder form to form a POSS modified-solder paste, and wherein the soldering of step (b) is selected from wave soldering and re-flow soldering.

24. The method of claim 20 wherein the high-melting metal matrix is a lead-free solder paste, the POSS is a POSS in liquid form, and step (a) comprises combining the lead-free solder paste with the POSS in liquid form with a flux to form a POSS modified-solder paste, and wherein the soldering of step (b) is selected from wave soldering and re-flow soldering.

25. The method of claim 20 wherein the high-melting metal matrix is a lead-based solder paste, the POSS is a POSS in liquid form, and step (a) comprises combining the lead-based solder paste with the POSS in liquid form with a flux to form a POSS modified-solder paste, and wherein the soldering of step (b) is selected from wave soldering and re-flow soldering.

26. An oilfield tool comprising an electronic component made using a modified-solder, wherein the modified-solder comprises:
(a) a high-melting metal matrix having a melting point of at least 175° C.; and
(b) from about 0.1 to about 20 weight percent, based on total weight of the modified-solder, of a strength-reinforcing additive dispersed in the metal matrix, the additive comprising a polyhedral oligomeric silsesquioxane.

27. An oilfield assembly for exploring for, drilling for, or producing hydrocarbons, comprising:
(a) one or more oilfield tools;
(b) one or more of the oilfield tools comprising an electronic component made using a modified-solder, the modified-solder comprising:
(i) a high-melting metal matrix having a melting point of at least 175° C.; and
(ii) from about 0.1 to about 20 weight percent, based on total weight of the modified-solder, of a strength-reinforcing additive dispersed in the metal matrix, the additive comprising a polyhedral oligomeric silsesquioxane.

28. A method of manufacturing an oilfield tool having soldered electronic components, the method comprising:
(a) providing a modified-solder comprising:
i) a high-melting metal matrix having a melting point of at least 175° C.; and
ii) from about 0.1 to about 20 weight percent, based on total weight of the modified-solder, of a strength-reinforcing additive dispersed in the metal matrix, the additive comprising a polyhedral oligomeric silsesquioxane (POSS); and
(b) soldering at least some of the components using the modified-solder.
